(19) United States
(12) Patent Application Publication
(10) Pub. No.: US 2025/0066599 A1
(43) Pub. Date: Feb. 27, 2025

(54) AQUEOUS POLYMER EMULSION AND USE THEREOF

(71) Applicant: Henkel AG & Co. KGaA, Düsseldorf (DE)

(72) Inventors: Xuan Xie, Shanghai (CN); XiaoKe Zhang, Shanghai (CN); Feng Zhu, Shanghai (CN); XiaoLong Hu, Shanghai (CN)

(21) Appl. No.: 18/944,267

(22) Filed: Nov. 12, 2024

Related U.S. Application Data
(63) Continuation of application No. PCT/CN2022/096830, filed on Jun. 2, 2022.

(51) Int. Cl. C08L 33/06

(52) U.S. Cl. CPC C08L 33/064; C08L 2201/52

(57) ABSTRACT

The present invention provides an aqueous polymer emulsion with satisfactory resistance to electrochemical deposition property and good porosity sealing performance on casting metals or parts co-molded by two different metal materials. The aqueous polymer emulsion comprises at least one (meth)acrylic polymer prepared by at least two monomers comprising at least one alkyl (meth)acrylate and at least one unsaturated carboxylic acid, at least one corrosion inhibitor, and at least one chelating agent, wherein the at least one unsaturated carboxylic acid is present in an amount of less than 3.5% by weight, based on the total weight of the monomers.

### TECHNICAL FIELD

The present invention relates to an aqueous polymer emulsion, and particularly relates to an aqueous polymer emulsion used as impregnating composition for vacuum impregnation and use thereof.

### BACKGROUND OF THE INVENTION

In metal castings such as casting aluminium, casting iron, and in electronic parts co-moulded by different metal materials such as stainless steel and aluminium, there are usually many fine pores. These fine pores may cause leakage problem, which presents a significant obstacle to commercial utility, particularly when such porous parts are employed in fluid power systems and other liquid handling applications.

One method to solve this problem is to disperse sealants on the pores of the part by a dispersing machine. This fixed-point dispersing way has a lot of disadvantages, it may change the dimension of the part, affect the appearance of the part, and the formed sealants are on the outside surface of the part, which may be easy to fail when an impact occurs. After failure, the sealant needs to be re-dispersed, which is costly and time-consuming.

Vacuum impregnation (VI) technology is an effective measure to seal porous parts without changing dimensional or functional characteristics. The vacuum impregnation technology is to infiltrate the impregnating agent into the fine pores of the metal part or component co-moulded by at least two different metal materials by vacuum-pressure process. When process of the vacuum impregnation is finished, the part is transferred to next processes i.e., cleaning process, the drying process or solidifying process where the impregnating agent forms sealant to fill the pores, to achieve the purposes of sealing and preventing leakage, and withstanding high pressure, thereby solves the leakage problem of the parts.

However, the impregnating composition in the art can deposit on the metal substrate, causing it difficult to be cleaned and washed. This becomes more severe when the part is co-moulded by at least two different metal materials, because an electrochemical deposition may occur. In electrochemical deposition, metal ions release to the solution and deposit on the surface of the substrates. The most cases of electrochemical mechanisms are the simple corrosion of metals in aqueous solutions, where atoms at the surface of the metal enter the solution as metal ions and electrons migrate through the metal to a site where, to sustain the reaction, they are consumed by species in contact with the metal. In more complicated cases, the metal ions move into solution by forming complex ions, or they combine with other species in the solution and precipitate compounds such as hydroxides, oxides, or sulfides. Electrochemical deposition on the metal substrate surface in aqueous solutions may cause emulsion breaking and polymer deposition, consequently, it is often observed that a large amount of solvent is required to wash the part. To sum up, electrochemical deposition of the impregnating composition has severely restricted the effectiveness of vacuum impregnation process in the electronics industry.

Therefore, there is a need to develop a vacuum impregnating composition having good resistance to electrochemical deposition on casting metals or parts co-molded by two different metal materials while good porosity sealing performance is unabated during the vacuum impregnation process.

### SUMMARY OF THE INVENTION

In one aspect of the present invention, provided is an aqueous emulsion comprising:
(a) at least one (meth)acrylic polymer prepared by at least two monomers comprising at least one alkyl (meth)acrylate and at least one unsaturated carboxylic acid,
(b) at least one corrosion inhibitor, and
(c) at least one chelating agent;
   wherein the at least one unsaturated carboxylic acid is present in an amount of less than 3.5% by weight, based on the total weight of the monomers.

In an additional aspect of the present invention, provided is a solidified product of an aqueous emulsion according to the present invention.

In an additional aspect of the present invention, provided is a part comprising the solidified product according to the present invention.

In an additional aspect of the present invention, provided is an electronic device, comprising the part according to the present invention.

In an additional aspect of the present invention, provided is a method for sealing porosity in a part.

The aqueous polymer emulsion of the present invention penetrates and fills voids in porous materials, casting metals or part co-molded by at least two metal materials. By using a vacuum process, air is removed from the porosity of parts to be impregnated and replaced with the components in the emulsion. After cleaning and solidifying, the part surface is shining and has barely any residues and particles.

In yet another aspect of the invention, provided is the use of the aqueous polymer emulsion according to the present invention in porosity sealing.

The aqueous emulsion of the present invention used as vacuum impregnating composition features satisfactory anti-electrochemical deposition performance and good porosity sealing property on casting metals or parts co-molded by two different metal materials. Additionally, it is effortless to prepare the aqueous emulsion of the present invention, and the vacuum impregnation process using the aqueous emulsion is suitable for commercial application.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

Unless specified otherwise, the recitation of numerical end points includes all numbers and fractions subsumed within the respective ranges, as well as the recited end points.

A “polymer,” as used herein and as defined by F W Billmeyer, JR. in Textbook of Polymer Science, second edition, 1971, is a relatively large molecule made up of the reaction products of smaller chemical repeat units. Polymers may have structures that are linear, branched, star shaped, looped, hyperbranched, crosslinked, or a combination thereof; polymers may have a single type of repeat unit (“homopolymers”), or they may have more than one type of repeat unit (“copolymers”). Copolymers may have the various types of repeat units arranged randomly, in sequence, in blocks, in other arrangements, or in any mixture or combination thereof.

“Polymerization” herein means the process of reacting monomers to form polymer. In the practice of the present invention, the process of polymerization is aqueous emulsion polymerization. The resulting polymer is known synonymously as a latex or as an emulsion polymer.

The molecular weights refer to number average molecular weights (Mn), unless otherwise stipulated. All molecular weight data refer to values obtained by gel permeation chromatography (GPC), unless otherwise stipulated, e.g. according to DIN 55672.

The term (meth)acrylate or (meth)acrylic represents acrylate/acrylic and methacrylate/methacrylic both.

All references cited in the present specification are hereby incorporated by reference in their entirety.

Unless otherwise defined, all terms used in the present invention, including technical and scientific terms, have the meaning as commonly understood by one of the ordinary skilled in the art to which the present invention belongs.

The present invention is directed to an aqueous polymer emulsion, comprising:
(a) at least one (meth)acrylic polymer prepared by at least two monomers comprising at least one alkyl (meth)acrylate and at least one unsaturated carboxylic acid,
(b) least one corrosion inhibitor, and
(c) at least one chelating agent;
   wherein the at least one unsaturated carboxylic acid is present in an amount of less than 3.5% by weight, based on the total weight of the monomers.

### (Meth)Acrylic Polymer

According to the present invention, the aqueous polymer emulsion comprises at least one (meth)acrylic polymer prepared by at least two monomers comprising at least one alkyl (meth)acrylate and at least one unsaturated carboxylic acid. The at least one unsaturated carboxylic acid is present in an amount of less than 3.5% by weight, based on the total weight of the monomers.

The at least one unsaturated carboxylic acid may be selected from (meth)acrylic acid, crotonic acid, itaconic acid, cinnamic acid, linolenic acid, oleic acid and combination thereof, and preferably is (meth)acrylic acid.

In one preferred embodiment, the at least one unsaturated carboxylic acid is present in the aqueous polymer emulsion in an amount of no more than 3% by weight, preferably from 0.01% to 3% by weight, and more preferably from 0.5% to 2.8% by weight, based on the total weight of the monomers. With an increase in the amount of the unsaturated carboxylic acid, the porosity sealing property of the aqueous polymer emulsion can be improved.

Examples of alkyl (meth)acrylate used in the present invention are C1 to C20 alkyl (meth)acrylates such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, and combination thereof, and preferably is selected from methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate. Preferred is C1 to C10 alkyl (meth)acrylate such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate. Such monomer can be used singly or in combination.

In preferred embodiments, the at least one alkyl (meth)acrylate is present in the aqueous polymer emulsion in an amount of from 35 to 67.5% by weight, preferably from 35 to 60% by weight, and more preferable from 35 to 50% by weight, based on the total weight of the monomers.

Other monomers which may be used as monomer to prepare the (meth)acrylic polymer. In one embodiment, the monomers to prepare the (meth)acrylic polymer further comprise at least one other monomer. Such other monomers include (meth)acrylate having at least one hydroxyl group, acrylonitrile, acrylamide, (meth)acrylamide, N-substituted (meth)acrylamide, hydroxy acrylamide, diacetone-acrylamide, vinyl ester such as vinyl acetate, vinyl ether such as isobutyl vinyl ether, styrene, alkyl- or halo-styrene, N-vinylpyrrolidone, vinyl chloride, vinylidene chloride, diacrylate monomer, silicon monomer, phosphate/polyphosphate monomer and combination thereof, preferably (meth)acrylate having at least one hydroxyl group.

Examples of (meth)acrylate having at least one hydroxyl group in the present invention are 2-hydroxyethyl (meth)acrylate, 2-hydroxypropyl (meth)acrylate, 3-hydroxypropyl(meth)acrylate, 2-hydroxybutyl (meth)acrylate, 4-hydroxybutyl (meth)acrylate, 1,4-cyclohexanedimethanol mono(meth)acrylate, glycerol mono(meth)acrylate, polyethylene glycol mono(meth)acrylate, polypropylene glycol mono(meth)acrylate, 2-hydroxy-3-phenoxypropyl(meth)acrylate, terminal hydroxyl group-containing lactone-modified (meth)acrylate, and combinations thereof, preferably selected from 2-hydroxyethyl (meth)acrylate, 2-hydroxypropyl (meth)acrylate, 3-hydroxypropyl(meth)acrylate, 2-hydroxybutyl (meth)acrylate, 4-hydroxybutyl (meth)acrylate, and combination thereof. The (meth)acrylate having at least one hydroxyl group can be used singly or in combination.

In preferred embodiments, when at least one (meth)acrylate having at least one hydroxyl group is used to prepare (meth)acrylic polymer of the present invention, it is present in an amount of from 0.5 to 15% by weight, preferably from 0.5 to 10% by weight, and more preferably from 0.5 to 6% by weight, based on the total weight of the monomers.

In some embodiments, the (meth)acrylic polymer in the present invention has a number average molecular weight (Mn) of from 20,000 to 2,000,000 g/mol, preferably from 50,000 to 1,000,000 g/mol, and more preferably from 100,000 to 500,000 g/mol, measured by gel permeation chromatography (GPC).

In some embodiments, the (meth)acrylic polymer in the present invention has a D₅₀ particle size of from 0.1 to 1.0 μm, preferably from 0.25 to 0.85 μm, more preferably from 0.40 to 0.70 μm, and even more preferably from 0.50 to 0.60 μm.

Herein, the “D₅₀ particle size” of the (meth)acrylic polymer represents a median diameter in a volume-basis particle size distribution curve obtained by measurement with a laser diffraction particle size analyzer.

In some embodiments, the (meth)acrylic polymer in the present invention has a glass transition temperature of −40° C. to 10° C., preferably of from −30° C. to 0° C., and more preferably of from −20° C. to −10° C.

Herein, the glass transition temperature is determined using Differential Scanning Calorimetry (TA DSC Q2000) according to the following process. The sample is equilibrated to 40° C., cooled to −80° C. for 2 minutes, then heated from −80° C. to 60° C. at a rate of 10° C. per minute (° C./min), and cooled from 60° C. to room temperature at a rate of 20° C./min. The presence of a step increases in heat flow during the heating from −80° C. to 60° C. indicates that the glass transition has occurred. The glass transition temperature is defined as the temperature at which the heat flow is at the midpoint of the step change.

In preferred embodiments, the (meth)acrylic polymer used in the present invention can be in a form of (meth)acrylic polymer emulsion prepared by emulsion polymerization which is well known in the art. In the practice, a reactive mixture containing monomers of the present invention, water, one or more emulsifier, and one or more initiator is provided in a reaction vessel. The ingredients of the reactive mixture may be brought together in any manner. For example, two or more of the ingredients of the reactive mixture, or portions thereof, may be mixed together before the mixture of those ingredients or portions thereof is placed into the reaction vessel. For example, any ingredients or portions thereof that are not mixed together outside of the reaction vessel may be added simultaneously or sequentially to the reaction vessel. Any combination of the above methods of providing the ingredients of the reactive mixture may be used. After a reactive mixture is present in the reaction vessel, conditions are provided in which the reactive mixture undergoes emulsion polymerization. For example, conditions will be provided as needed for the initiator to form one or more free radical. That is, depending on the initiator used, for example, the reaction mixture may be heated, or a reductant may be added, or the reactive mixture may be exposed to radiation, or a combination thereof. Also, it is contemplated that other conditions that allow emulsion polymerization to succeed (such as, for example, emulsification of monomer, concentration of monomer, concentration of initiator, etc.) will also be provided. In some embodiments, the conditions in which the reactive mixture undergoes emulsion polymerization will be established simultaneously with the introduction of the reactive mixture into the reaction vessel. For example, if the ingredients of the reactive mixture are not added simultaneously, in some embodiments the conditions in which the reactive mixture undergoes emulsion polymerization may be established simultaneously with the introduction of the final ingredient of the reactive mixture into the reaction vessel. It is contemplated that, in some embodiments, after the conditions in which the reactive mixture undergoes emulsion polymerization are established, additional monomer may be added, additional water may be added, additional emulsifier may be added, additional initiator may be added, or any mixture or combination thereof.

It is also possible to use commercially available the (meth)acrylic polymer in the present invention. Examples thereof include DE-B and DE-E polymer emulsion, commercially available from Wanhua Chemical Co., Ltd.

With particular preference, the (meth)acrylic polymer in the invention is present in an amount of from 40.0% to 70.0% by weight, preferably from 45.0% to 70.0% by weight, based on the total weight of the aqueous polymer emulsion.

### Corrosion Inhibitor

According to the present invention, the aqueous polymer emulsion further comprises at least one corrosion inhibitor. Generally, when electrochemistry corrosion occurs on metal surface, metal ions that released from metal substrate surface induce emulsion breaking therefore leading to deposition. Corrosion inhibitor is generally desired in compositions to suppress release of metal ions and prevent emulsion breaking so as to improve anti-electrochemical deposition performance.

In some embodiments, corrosion inhibitor of the present invention is a zinc-based corrosion inhibitor, phosphate-based corrosion inhibitor, carboxylate-based corrosion inhibitor, ion-exchange silica-based corrosion inhibitor and an organic corrosion inhibitor. Such corrosion inhibitor can be used singly or in combination.

Examples of suitable corrosion inhibitors include, but are not limited to, sulphonates, phosphines, oxides and silicates; zinc oxide, zinc phosphate, zinc borate, zinc molybdate, barium metaborate, calcium borosilicate, barium sulfate, aluminum phosphate, magnesium oxide, strontium zinc phosphosilicate.

Examples of zinc-based corrosion inhibitors include, for example, VOK®-AP 179, commercially available from VOK; and HEUCOPHOS ZPA and ZAPP zinc aluminum phosphate, HEUCOPHOS ZAM and ZMP zinc molybdenum phosphates, HEUCOPHOS ZPO zinc orthophosphates, commercially available from Heucotech. Examples of phosphate-based corrosion inhibitors include, for example, micronized HALOX SZP-39 1, HALOX 430 calcium phosphate, HALOX ZP zinc phosphate, HALOX SW-ill strontium phosphosilicate, HALOX 720 mixed metal phosphorcarbonate, and HALOX 700, 550 and 650 proprietary organic corrosion inhibitors commercially available from Halox, Hammond, Ind. Examples of carboxylate-based corrosion inhibitors include, for example, ASCOTRAN® H14 and ASCOTRAN® NSC, commercially available from Ascotec. Example of organic acid-based corrosion inhibitor is KH 7026 available from HPM New Material (Shanghai) Co., LTD. Examples of ion-exchange silica-based corrosion inhibitor include Shieldex® CS313, Shieldex® 303, commercially available from Grace, and NOVINOX XCA02, commercially available from SNCZ. Other suitable corrosion inhibitors may include HEUCOPHOS SAPP and SRPP strontium aluminum polyphosphate hydrates, and HEUCOPHOS CAPP calcium aluminum polyphosphates, commercially available from Heucotech.

With particular preference, the corrosion inhibitor is present in aqueous polymer emulsion in an amount of from 0.01% to 5.0% by weight, preferably from 0.03% to 3.5% by weight, based on the total weight of the aqueous polymer emulsion.

### Chelating Agent

According to the present invention, the aqueous polymer emulsion further comprises at least one chelating agent. The chelating agent can capture metal ions on substrate and to prevent aggregation of polymer particles in an aqueous media and therefore enhances the anti-electrochemical deposition property on metals.

Usually, the ligands are organic compounds and are called chelants, chelators, chelating agents, or sequestering agents, which in embodiments of the invention may be biodegradable.

Exemplary of chelating agents which may be employed in the present invention are selected from ethylenediaminetetraacetic acid acid N-(EDTA), diethylenetriaminepentacetic (DTPA), (hydroxyethyl)ethylene-diaminetetraacetic acid (HEDTA), nitrilotriacetic acid (NTA), 2,3-dimercaptosuccinic acid (DMSA), citric acid, salicylic acid or its amino or sulfonic derivatives, and combination thereof. In addition to the acid forms of the chelating agent, the salts which may be employed include alkali metal salts, such as sodium, disodium, or tetrasodium salts, diammonium salts, and tetraammonium salts as well as other salts. The physical form of the chelating agent includes liquids, powder, and crystal forms.

Commercially DTPA-based, HEDTA-based, and NTA-based chelating agents are available from Dow Chemical Company, Midland Mich and Shijiazhuang Jackchem Co., Ltd.

With particular preference, the chelating agents is present in the aqueous polymer emulsion in an amount of from 0.01 to 5.0% by weight, preferably from 0.01 to 3.0% by weight, based on the total weight of the aqueous polymer emulsion.

### Water

According to the present invention, water, preferably deionized water is contained in the polymer emulsion. Preferably, water is present in the polymer emulsion in an amount of from 29.98% to 50.00% by weight, preferably from 34.00 to 50.00% by weight, based on the total weight of the aqueous polymer emulsion.

### Other Additives

Additives may be added to improve stability of the emulsion and meet different mechanical and rheological demands, such as humectant, skin time extender, adhesion promoter, thickener, defoamer, pH regulator and combination thereof.

Non-limiting example of humectant include betaine, glycerol, D-sorbitol, polyglycol, polyoxyethylenesorbitan, sodium lactate, and combination thereof. It is commercially available from Sinopharm Group. If present, the preferred amount of humectant used in the present invention is from 0.01 to 10.0%, preferably of from 0.1 to 3.0%, and more preferably of from 0.2 to 0.6%, based on total weight of the aqueous polymer emulsion.

Non-limiting example of thickener includes a hydroxypropyl methyl cellulose thickener. Preferably, these thickeners are chosen from hydroxymethyl cellulose (HEA), hydroxyethyl cellulose (CMC), BASF VISCALEX AT88, OMG Borch Gel ALA, Contex COAPUR™ 2025 et al. If present, the preferred amount of thickener used in the present invention is from 0.01 to 3.0%, preferably of from 0.1 to 1.0%, and more preferably of from 0.2 to 0.5%, based on total weight of the aqueous polymer emulsion.

Non-limiting examples of defoamer is oil based defoamer, e.g. paraffin oil, mineral oil, silicone based defoamer, or a mixture of polyether and mineral oil. Such defoamers are commercially available under DFC171 from Shanghai Champion Chemical Co., Ltd., SN Defoamer 8370, 470, 485 from Sannopc, BYK-024 from BYK, Foamaster® MO 2134, Foamaster® MO 2150, Foamaster® NO 2335 and FoamStar® ST 2438 from BASF. If present, the preferred amount of defoamer of the present invention is from 0.001 to 3.0%, preferably of from 0.01 to 1.0%, and more preferably of from 0.1 to 0.3%, based on total weight of the aqueous polymer emulsion.

Anti-skinning agent e.g., polyhydroxy alcohols can be added to improve flowability and keep long skin time. Preferred anti-skinning agents can be chosen from Maltitol, Betaine, Sodium lactate available from Sinopharm Group, BYK-348 available from BYK group. Preferably adding amount is of from 0.1 to 1.5%, based on the total weight of the aqueous emulsion to get good wetting behavior (and long skin time under vacuum).

Adhesion promoters e.g., multifunctional organosilane or isocyanates crosslinkers can be added to improve the adhesion between inorganic materials such as plastic and organic polymers. Preferably, the adhesion promoter comprises at least one silane group, the silane group contained in the promoter can effectively improves the cohesion of the emulsion. Preferred examples are Dynasylan®GLYEO and Dynasylan®HYDROSIL 2926 from Evonik, WM44-L70G from Asahi Kasei, and TCI-E0327 available from TCI group. If present, the amount ranges from 0.1 to 1.5%, based on the total weight of the aqueous emulsion.

PH regulator e.g. acetic acid can be added to neutralize the alkaline chelating agent of the composition of the present invention.

### Aqueous Polymer Emulsion

Preferably, the aqueous polymer emulsion has a solid content of no less than 50% by weight, and preferably no less than 60% by weight. The solid content is desired to withstand air pressure or hydraulic pressure in commercially application.

Herein, the solid content is determined by drying 1-gram emulsion in a common furnace at temperature of 130° C. for 30 minutes and then weighing by a precision scale to calculate the solid content by percentage.

Preferably, the aqueous polymer emulsion of the present invention exhibits a viscosity of from 200 to 2000 cPs at 25° C., preferably a viscosity of from 500 to 1000 cPs at 25° C., preferably from 500 to 800 at 25° C., measured with Brookfield DV2t LV-02 using spindle 62 under 20 rpm.

In preferred embodiments, the aqueous polymer emulsion, based on the total weight of the aqueous polymer emulsion, comprising
(a) from 40.0% to 70.0%, preferably from 45.0% to 70%, by weight of at least one (meth)acrylic polymer prepared by at least two monomers comprising at least one alkyl (meth)acrylate and at least one unsaturated carboxylic acid,
(b) from 0.01% to 5.0%, preferably from 0.03% to 3.5%, by weight of at least one corrosion inhibitor,
(c) from 0.01% to 5.0%, preferably from 0.01% to 3.0%, by weight of at least one chelating agent, and
(d) from 29.98% to 50.0%, preferably from 34.0% to 50.0% by weight of water,
   wherein the at least one unsaturated carboxylic acid is present in an amount of less than 3.5% by weight, based on the total weight of the monomers.

It is an object of the present invention to make available aqueous polymer emulsion that are obtainable in a simple, industrially suitable, and reproducible manner. The aqueous polymer emulsion can be used as vacuum impregnation composition and exhibits satisfactory resistance to electrochemical deposition property and good porosity sealing property on casting metals or parts co-molded by two different metal materials.

### Solidified Product

In another aspect of the present invention, provided is a solidified product of the aqueous polymer emulsion according to this present invention.

In an additional aspect of the present invention, provided is a part comprising the solidified product according to the present invention.

In an additional aspect of the present invention, provided is an electronic device, comprising the part according to the present invention. Exemplary electronic devices encompass computers and computer equipment, such as printers, fax machines, scanners, keyboards and the like; household appliances; medical sensors; automotive sensors and the like; and personal electronic devices, such as telephones, mobile phones, calculators, remote controls, cameras, CD-players, DVD-players, cassette tape recorders, laptop and tablet computer and the like.

For the purpose of the present invention, the “solidified” described herein is intended to mean that the solid content contained in the emulsion to enter into the pores of a part having porosity to become sealant during the drying after impregnation process. This transformation is described as “solidification process” in the present invention, which can be a purely physical transformation or a post-crosslinking chemical reaction if hydrazide and acetoacetate groups are present. Typically, the impregnated part is heated ranging from about 40° C. to about 80° C. during the solidification process, but temperature outside of this range may be used when appropriate.

### Method for Sealing Porosity

In an additional aspect of the present invention, provided is a method for sealing porosity in a part, comprising a) vacuum impregnating the aqueous polymer emulsion according to the present invention into the part and b) solidifying the aqueous polymer emulsion at a temperature ranged from 40 to 80° C. for at least half hour and following by drying at room temperature for at least one day.

Basically, the aqueous polymer emulsion of the present invention penetrates and fills voids in porous materials, casting metals or part co-molded by at least two different metals in particularly. By using a vacuum process, air is removed from the porosity of parts to be impregnated and replaced with the agents in the emulsion. The impregnated part then is washed, and the aqueous polymer emulsion is solidified.

To be specific, in the vacuum impregnation process, normally there is an impregnation chamber to place part to be impregnated. The penetration of the aqueous emulsion of the present invention into the porosity of the parts may optionally be assisted by pressurizing the impregnation chamber using compressed air. Typical processes employing the aqueous emulsion of the present invention with reference to impregnating of porous parts contained in a basket which is introduced into the impregnation chamber. This is the typical method if the parts are of suitably small size. In the case of larger parts, the same are typically mounted on or suspended from hoist or carrier. In the wet vacuum impregnation process, the basket of porous parts is submerged into a vacuum tank which is full of aqueous emulsion of the present invention. A short-term, e.g., 10-12-minute, vacuum cycle removes air from the porosity of the parts. The chamber then is returned to ambient pressure, with the emulsion penetrating into the evacuated porosity.

The wet vacuum impregnation process is similarly conducted, but with the impregnation chamber being pressurized at the end of the vacuum cycle to drive impregnating composition further into small porosity passages. In the dry vacuum impregnation method, the basket of porous parts is placed directly in the dry vacuum chamber. Air is evacuated from the porosity in the parts for a selected length of time, e.g., 10 minutes. A transfer valve then is open, allowing aqueous emulsion of the present invention to enter the vacuum chamber from a storage reservoir. The chamber is automatically pressurized to force aqueous emulsion of the present invention into the parts. After impregnation, while the said emulsion is being returned to the reservoir, a free fall then suspends the basket to remove excess surface emulsion. Among the foregoing methods, wet vacuum impregnation techniques are generally more widely employed than the dry vacuum impregnation process, however, either process is suitable for use in the present invention.

Following the initial impregnation step, the impregnated parts are optionally transferred to an agitated water rinse zone, for removal of any remaining emulsion trapped in groove or screw hole of the impregnated parts. The agitation of the water rinse zone may be affected by movement of the basket or suspended parts in such zone and/or mechanical means for effecting circulation of water therein. Water or surfactants or alkali solution and very few alcohols can be used to rinse. In case of a small porous part contained in a basket, it frequently is desirable to operate the water rinse zone in a “tumbling basket” mode to enhance the washing effect. Thereafter, the impregnated parts may be transferred to a solidification zone at temperature from 40° C. to 80° C. for at least half an hour. to warm the impregnated parts for solidification, a self-crosslinking reaction may be occurred. In impregnation systems wherein room temperature is used, after the impregnation process, the parts could be transferred to furnace for drying and then cool down at room temperature for overnight. In use, the impregnation composition may be conventionally employed in an impregnation chamber of typical construction, wherein a “wet” or “dry” vacuum is imposed on the porous parts to be impregnated and the evacuated porous parts contact the impregnation composition at higher, e.g. ambient pressure, whereby the impregnant composition pass into the porosity of the porous parts to effect impregnation thereof.

In yet another aspect of the invention, provided is the use of the aqueous polymer emulsion according to the present invention in porosity sealing.

The aqueous emulsion of the present invention used as impregnating composition features satisfactory resistance to electrochemical deposition property and good porosity sealing performance on casting metals or parts co-molded by two different metal materials. Additionally, both preparing the emulsion of the present invention and the technique of vacuum impregnation using thereof as well as its post processing is simple for commercial use.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Materials

DE-B is aqueous emulsion of (meth)acrylic polymer prepared by monomers comprising alkyl (meth)acrylates and 2.8% by weight of (meth)acrylic acid, based on the total weight of the monomers, and has a polymer content of from 55 to 65%, based on the total weight of the aqueous emulsion, available from Wanhua Chemical Co., Ltd.

DE-E is aqueous emulsion of (meth)acrylic polymer prepared by monomers comprising alkyl (meth)acrylates, hydroxyalkyl (meth)acrylate and 0.5% by weight of (meth)acrylic acid, based on the total weight of the monomers, and has a polymer content of from 55 to 65%, based on the total weight of the aqueous emulsion, available from Wanhua Chemical Co., Ltd.

DE-H is aqueous emulsion of (meth)acrylic polymer prepared by monomers comprising alkyl (meth)acrylates and 3.5% by weight of (meth)acrylic acid, based on the total weight of the monomers, and has a polymer content of from 55 to 65%, based on the total weight of the aqueous emulsion, available from Wanhua Chemical Co., Ltd.

DFC171 is defoamer available from Shanghai Champion Chemical Co., Ltd.

SN Defoamer 8370 is defoamer of a mixture from mineral oil, polyether, silica and water, available from Sannopco.

ASCOTRAN™ H14 is a carboxylate-based corrosion inhibitor preventing flash rust, available from Ascotec.

VOK™-AP 179 is a zinc-based corrosion inhibitor, available from VOK.

DTPA is diethylenetriaminepentaacetic acid, pentasodium salt, available from SHIJIAZHUANG JACKCHEM CO., LTD.

Betaine is available from Sinopharm Group.

Rheobyk-HV 80 is VOC-free associative thickener, available from BYK Group.

Acetic acid is available from Sinopharm Group.

### Test Methods

### Anti-Electrochemical Deposition Performance

Two laminates were made of stainless steel SUS304 and aluminium Al6061 with thickness of 2 mm, length of 25.4 mm and width of 76.2 mm respectively. Two laminates were moulded by pressure to form a so-called “bi-stratal metal” as the testing part. The testing part was placed into the emulsion of examples described in the present invention for 30 minutes. Afterwards, the testing part was taken out to proceed with the following cleaning schedule:
Step 1: immersed the testing part in a tank containing 1 to 2 wt % cleaning agent at room temperature for 1 to 3 minutes, and during the process, air was introduced through the tank;
Step 2: repeated Step 1 for two times by taking out of the testing part and put it into fresh tank with the same arrangement as in Step 1;
Step 3: took out the testing part and put it into a tank containing 1 to 2 wt % cleaning agent at 45° C. for 2 to 4 minutes, during the process, air was introduced through the tank and the testing part was vibrated with high frequency; and
Step 4: took out the testing part from the tank in Step 3 and put it into a tank containing deionized water at 40° C. for 1 to 3 minutes.
After cleaning, the testing part was dried at 60° C. for 30 minutes or at room temperature for 6 to 12 hours to observe the appearance by counting the number of galvanic deposition spots.

The anti-electrochemical deposition performance of each example of the present invention was rated by the following scale:

| Scale | Appearance Description |
|---|---|
| A | No galvanic deposition spots or the galvanic deposition spots in an |
| | amount of less than 5 |
| B | the galvanic deposition spots in an amount of from 5 to less than |
| | 10 |
| C | the galvanic deposition spots in an amount of from 10 to less than |
| | 20 |
| D | the galvanic deposition spots in an amount of from 20 to less than |
| | 40 |
| E | the galvanic deposition spots in an amount of from more than 40 |

A level was preferred, and B-level was considered as acceptable.

### Leakproof Performance

Leakproof performance of the composition of the present invention was evaluated based on two testing parts made of anodized aluminum and stainless steel SUS304 sheet respectively. Both two types of part had fine pores. The vacuum impregnation was processed using the emulsion of examples described in the present invention. Specifically, the testing parts were placed into the vacuum impregnation tank. The vacuum stage was kept for several minutes and then the vacuum was broken to enable the fine pores of the parts to be impregnated by the emulsion. In the impregnation stage, 5 bar compressed air was introduced through the tank cover to pressurize the vacuum impregnation tank. After the impregnation stage, the vacuum impregnation tank was opened, and the testing part was taken out to execute the following cleaning schedule cleaning schedule:
Step 1: immersed the testing part in a tank containing 1 to 2 wt % cleaning agent at room temperature for 1 to 3 minutes, and during the process, air was introduced through the tank;
Step 2: repeated Step 1 for two times by taking out of the testing part and put it into fresh tank with the same arrangement as in Step 1;
Step 3: took out the testing part and put it into a tank containing 1 to 2 wt % cleaning agent at 45° C. for 2 to 4 minutes, during the process; and
Step 4: took out the testing part from the tank and put it into a tank containing deionized water at 40° C. for 1 to 3 minutes.
After cleaning, the testing part was dried at 60° C. for 30 minutes or at room temperature for 6 to 12 hours to observe the appearance.

5 samples were tested for each example using the two testing parts. Each one's air leakage amount was recorded if any, and the average leakage air amount was calculated by arithmetic mean to evaluate the leakage property by the following scale:

| Scale | Average air leakage amount (mL/min) |
|---|---|
| A | 0 |
| B | More than 0 and less than 0.05 |
| C | From 0.05 to less than 0.1 |
| D | From 0.1 to less than 0.2 |
| E | From 0.2 to less than 0.5 |
| F | From 0.5 to less than 0.8 |

A level was preferred, and A or B-level was considered as acceptable.

### Examples 1 to 6 (Ex.1 to Ex.6) and Comparative Examples 1 to 3 (CE.1 to CE. 3)

The emulsions were prepared with the following method using components in amounts (parts by weight) listed in the Table 1, and the properties were tested using the methods stated above, and the results of evaluations are shown in Table 1.

Generally, there is no limitation to prepare the aqueous emulsion as long as the components described herein is mixed homogeneously, a preferable preparation method comprises the following steps:
(1) preparing aqueous emulsion of the (meth)acrylic polymer of the present invention;
(2) adding defoamer, if any, into the emulsion obtained from step (1);
(3) adding chelating agent and corrosion inhibitor and other additives such as humectant, skin time extender, adhesion promoter, if any, and mixing; and
(4) adding thickener into the emulsion obtained from step (3) and mixing to homogeneity.

| Components | CE 1 | CE 2 | CE 3 | Ex 1 | Ex 2 | Ex 3 | Ex 4 | Ex 5 | Ex 6 |
|---|---|---|---|---|---|---|---|---|---|
| DE-B | 99.8 | 0 | 0 | 98.85 | 98.15 | 97.65 | 0 | 0 | 0 |
| DE-E | 0 | 0 | 99 | 0 | 0 | 0 | 97.77 | 97.07 | 96.37 |
| DE-H | 0 | 98.18 | 0 | 0 | 0 | 0 | 0 | 0 | 0 |
| DFC171 | 0 | 0 | 0 | 0 | 0 | 0 | 0 | 0 | 0 |
| SN Defoamer | 0.2 | 0.2 | 0.2 | 0.2 | 0.2 | 0.2 | 0.2 | 0.2 | 0.2 |
| 8370 | | | | | | | | | |
| ASCOTRAN ™ | 0 | 0.5 | 0 | 0.5 | 0.5 | 0.5 | 0 | 0 | 0 |
| H14 | | | | | | | | | |
| KH 7026 | 0 | 0 | 0 | 0 | 0 | 0 | 0 | 0 | 0 |
| VOK ™-AP 179 | 0 | 0 | 0.8 | 0 | 0 | 0 | 0.3 | 1 | 1.7 |
| DTPA | 0 | 1 | 0 | 0.5 | 1 | 1.5 | 1 | 1 | 1 |
| Betaine | 0 | 0 | 0 | 0 | 0 | 0 | 0.5 | 0.5 | 0.5 |
| Rheobyk-HV 80 | 0 | 0 | 0 | 0 | 0 | 0 | 0.23 | 0.23 | 0.23 |
| Acetic acid | 0 | 0.12 | 0 | 0.15 | 0.15 | 0.15 | 0 | 0 | 0 |
| Solid Content | 61.90% | 61.80% | 62.33% | 62.36% | 62.36% | 62.36% | 61.63% | 62.60% | 61.11% |
| Test Results | | | | | | | | | |
| Anti- | D | C | C | B | B | A | B | A | A |
| electrochemical | | | | | | | | | |
| deposition | | | | | | | | | |
| performance | | | | | | | | | |
| AnAl leakproof | A | A | A | A | A | B | A | A | B |
| SUS leakproof | A | A | A | A | A | A | A | A | A |

As can be seen from Table 1, the emulsions in the inventive examples exhibited satisfactory anti-electrochemical deposition performance and good porosity sealing performance on metals compared to the comparative examples.

Although some preferred embodiments have been described, many modifications and variations may be made thereto in light of the above teachings. It is therefore to be understood that the invention may be practiced otherwise than as specifically described without departing from the scope of the appended claims.

1. An aqueous polymer emulsion, comprising
(a) at least one (meth)acrylic polymer prepared by at least two monomers comprising at least one alkyl (meth)acrylate and at least one unsaturated carboxylic acid,
(b) at least one corrosion inhibitor, and
(c) at least one chelating agent;
wherein the at least one unsaturated carboxylic acid is present in an amount of less than 3.5% by weight, based on the total weight of the monomers.

2. The aqueous polymer emulsion according to claim 1, wherein the at least one unsaturated carboxylic acid is selected from acrylic acid, methacrylic acid, crotonic acid, itaconic acid, cinnamic acid, linolenic acid, oleic acid or a combination thereof.

3. The aqueous polymer emulsion according to claim 1, wherein the at least one unsaturated carboxylic acid is present in an amount of no more than 3% by weight, based on the total weight of the monomers.

4. The aqueous polymer emulsion according to claim 1, wherein the at least one alkyl (meth)acrylate is selected from methyl (meth) acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth) acrylate, tridecyl (meth)acrylate, tetradecyl(meth) acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, or a combination thereof.

5. The aqueous polymer emulsion according to claim 1, wherein the at least two monomers further comprises at least one other monomer, selected from (meth)acrylate having at least one hydroxyl group, acrylonitrile, acrylamide, (meth)acrylamide, N-substituted (meth)acrylamide, hydroxy acrylamide, diacetone-acrylamide, vinyl ester, vinyl ether, styrene, alkyl- or halo-styrene, N-vinylpyrrolidone, vinyl chloride, vinylidene chloride, diacrylate monomer, silicon monomer, phosphate/polyphosphate monomer or a combination thereof.

6. The aqueous polymer emulsion according to claim 5, wherein the (meth)acrylate having at least one hydroxyl group is selected from 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 1,4-cyclohexanedimethanol mono(meth)acrylate, glycerol mono(meth)acrylate, polyethylene glycol mono(meth)acrylate, polypropylene glycol mono(meth)acrylate, 2-hydroxy-3-phenoxypropyl(meth)acrylate, terminal hydroxyl group-containing lactone-modified (meth)acrylate, or combinations thereof.

7. The aqueous polymer emulsion according to claim 1, wherein the at least one (meth)acrylic polymer has a number average molecular weight of from 20,000 to 2,000,000 g/mol, measured by gel permeation chromatography (GPC).

8. The aqueous polymer emulsion according to claim 1, wherein the at least one corrosion inhibitor is selected from a zinc-based corrosion inhibitor, phosphate-based corrosion inhibitor, carboxylate-based corrosion inhibitor, ions-exchange silica-based corrosion inhibitor, an organic corrosion inhibitor, or a combination thereof.

9. The aqueous polymer emulsion according to claim 1, wherein the at least one chelating agent is selected from ethylenediaminetetraacetic acid (EDTA), diethylenetriaminepentacetic acid (DTPA), N-(hydroxyethyl)ethylene-diaminetetraacetic acid (HEDTA), nitrilotriacetic acid (NTA), 2,3-dimercaptosuccinic acid (DMSA), citric acid, salicylic acid or its amino or sulfonic derivatives, alkali metal salts selected from sodium, disodium, or tetrasodium salts, diammonium salts, tetraammonium salts, or a combination thereof.

10. The aqueous polymer emulsion according to claim 1, wherein the aqueous polymer emulsion further comprises at least one additive selected from humectant, thickener, defoamer, skin time extender, adhesion promoter, pH regulator or a combination thereof.

11. The aqueous polymer emulsion according to claim 1, wherein the aqueous polymer emulsion has a solid content of no less than 50% by weight.

12. A solidified product of the aqueous polymer emulsion according to claim 1.

13. An article comprising the solidified product according to claim 12.

14. A method for sealing porosity in a part, comprising a) vacuum impregnating the aqueous polymer emulsion according to claim 1, into the part and b) solidifying the aqueous polymer emulsion at a temperature ranged from 40 to 80° C. for at least half hour and following by drying at room temperature for at least one day.

15. (canceled)
